(19) United States
(12) Patent Application Publication
(10) Pub. No.: US 2013/0153556 A1
(43) Pub. Date: Jun. 20, 2013

(54) LASER MACHINING METHOD FOR METALLIC WORKPIECE

(71) Applicant: LI-YING WANG HE, Tu-Cheng (TW)

(72) Inventor: LI-YING WANG HE, Tu-Cheng (TW)

(73) Assignee: HON HAI PRECISION INDUSTRY CO., LTD., Tu-Cheng (TW)

(21) Appl. No.: 13/472,659

(22) Filed: May 16, 2012

(30) Foreign Application Priority Data
Dec. 15, 2011 (TW) 100146372

(51) Int. Cl. B23K 26/00

(52) U.S. Cl. 219/121.72

(57) ABSTRACT

A laser machining method for metallic workpiece, including providing a metallic workpiece, heating the metallic workpiece with a heater controller, and machining the metallic workpiece with a laser beam.

### BACKGROUND

1. Technical Field

The present disclosure generally relates to laser machining methods, and particularly to a laser machining method for metallic workpiece.

2. Description Of Related Art

Laser machining is a technology that uses a laser to machine workpieces, and is typically used for industrial manufacturing applications. Laser machining works by directing the output of a high-power laser at the metallic workpiece to be machined, and part of the material of the metallic workpiece then melts, burns, and vaporizes away to form the desired shape in the metallic workpiece. However, high temperatures are generated in the machining process. The initial temperature of the metallic workpiece is generally at room temperature, and the melted metal of the metallic workpiece will solidify to form protrusions on the machining surface of the metallic workpiece because of the temperature difference between the base of the metallic workpiece and the machining surface. The protrusions will affect the surface precision of the machining surface of the metallic workpiece.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is plan view of an embodiment of a laser machining for metallic workpieces.

FIG. 2 is a flowchart of an embodiment of a laser machining method for metallic workpiece.

### DETAILED DESCRIPTION

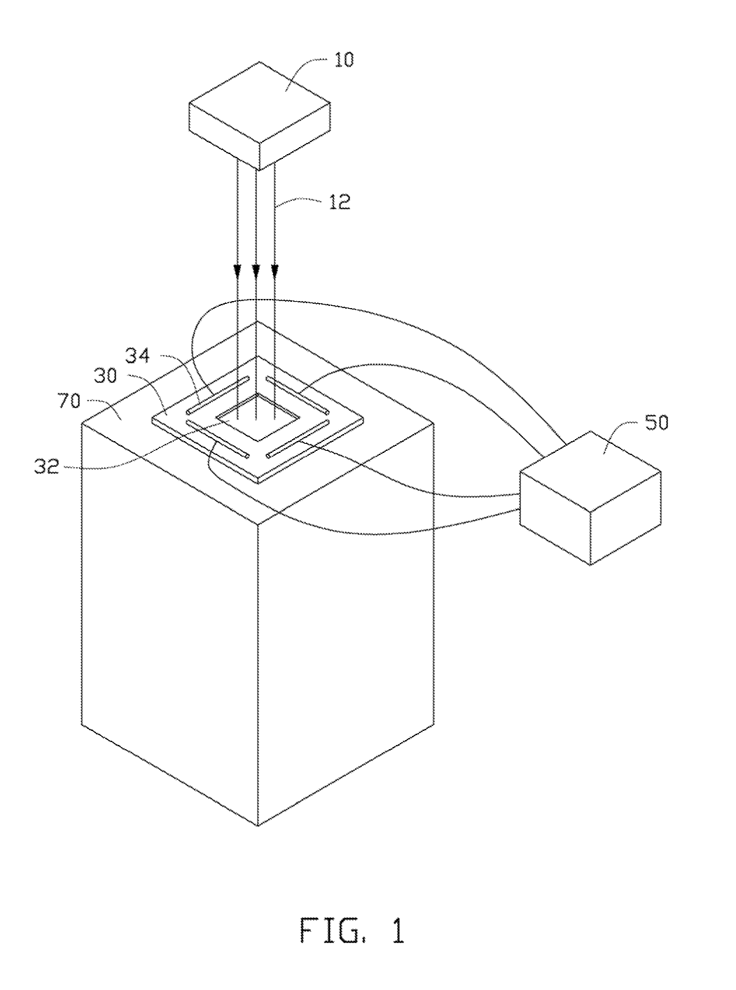

FIG. 1 shows a laser 10 producing laser beams 12 for machining a metallic sheet 30. The metallic sheet 30 positioned on a worktable 70 is electrically connected to a heat controller 50. In the illustrated embodiment, the laser 10 is used for cutting a groove 32 with a high-quality surface in the metallic sheet 30. In alternative embodiments, the laser 10 can be used for forming other marks on a metallic workpiece.

In the illustrated embodiment, the laser 10 is a semiconductor laser. In alternative embodiments, the laser 10 can be other solid-state lasers, such as photonic crystal lasers, and fiber lasers or gas lasers. The metallic sheet 30 is made of iron. The metallic sheet 30 can be made of magnesium, aluminum, zinc, magnesium alloy, aluminum alloy, zinc alloy or other metals or metal alloys. The metallic sheet 30 is rectangular. Four heating rods 34 are respectively fixed on four edges of the metallic sheet 30. The four heating rods 34 are electrically connected to the heat controller 50. The heat controller 50 is used for controlling a temperature of the four heating rods 34 to heat the metallic sheet 30. The worktable 70 is used for locating and fixing the metallic sheet 30. In order to control a temperature of the metallic sheet 30, some heat insulating materials such as asbestos can be filled between the worktable 70 and the metallic sheet 30.

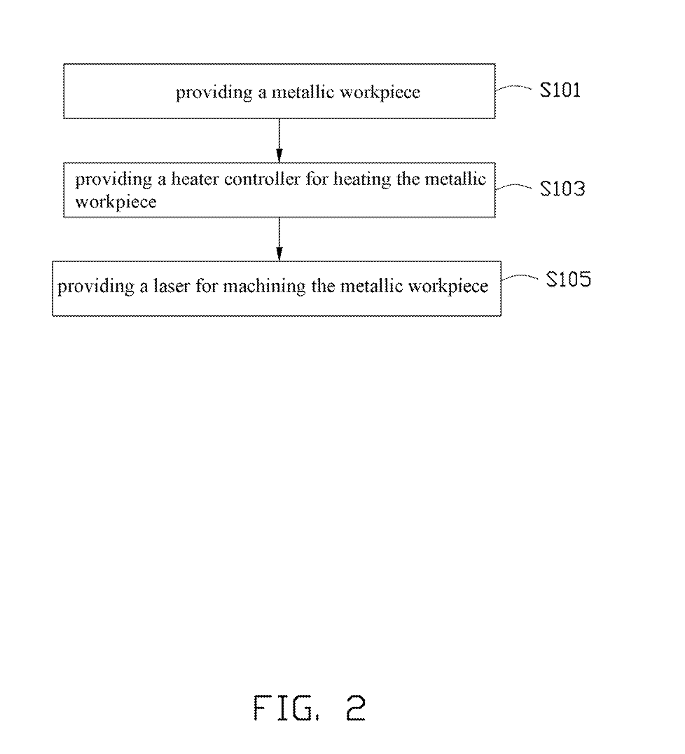

FIG. 2 shows an embodiment of a layer method for manufacturing a metallic workpiece illustrated as follows.

In step S101, a metallic sheet 30 is provided. In the illustrated embodiment, the metallic sheet 30 is made of iron. Four heating rods 34 are respectively fixed on the four edges of the metallic sheet 30.

In step S103, a heater controller 50 is provided. The four heating rods 34 are electrically connected to the heat controller 50. In the illustrated embodiment, the temperature of the metallic sheet 30 is controlled to be in a range from about 120° C. to about 278° C. In alternative embodiments, the number of the heating rods 34 can be one, two, or more.

In step S105, a laser 10 is provided. The laser 10 transmits a laser beam 12 to machine the metallic sheet 30 to define a groove 32 at about the center of the metallic sheet 30.

A first embodiment of the laser machining method for defining a groove 32 at about the center of the metallic sheet 30 includes the following steps. First, a metallic sheet 30 made of iron is provided. Second, a heat controller 50 is provided and the metallic sheet 30 is heated to be 50° C. Third, a laser 10 is provided to machine a groove 32 at about the center of the metallic sheet 30. The radiation frequency of the laser 10 is 30 KHz, and the radiation time of the laser 10 is 570 μs.

A second embodiment of the laser machining method for machining a groove 32 at about the center of the metallic sheet 30 is similar to the first embodiment, except that the temperature of the metallic sheet 30 is 120° C.

A third embodiment of the laser machining method for machining a groove 32 at about the center of the metallic sheet 30 is similar to the first embodiment, except that the temperature of the metallic sheet 30 is 180° C.

A fourth embodiment of the laser machining method for machining a groove 32 at about the center of the metallic sheet 30 is similar to the first embodiment, except that the temperature of the metallic sheet 30 is 278° C.

A contrast embodiment of machining a groove 32 at about the center of the metallic sheet 30 using laser is similar to the first embodiment, except that the temperature of the metallic sheet 30 is at a room temperature, in this embodiment, the room temperature is about 20° C.

The first, the second, the third, and the fourth embodiments are compared with the contrast embodiment by visual inspection method. The surface of the groove 32 of the first embodiment has no improvement other than a smoothness of the surface of the contrast embodiment. However, protrusions generated on the surface of the groove 32 decrease as the temperature of the metallic sheet increases, and a maximum smoothness is reached on the surface of the grooves 32 from the second embodiment to the fourth embodiment. That is to say the surface precision of the groove 32 is improved when the temperature of the metallic sheet 30 is more than about 120° C.

The increase of the temperature of the metallic sheet 30 can reduce a temperature difference between the surface of the groove 32 and a base of the metallic sheet 30, which can reduce a heating effect on the surface of the groove 32 and improve the surface precision of the surface of the groove 32.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A laser machining method for metallic workpiece, comprising:
providing a metallic workpiece;
heating the metallic workpiece with a heater controller; and
machining the metallic workpiece with a laser beam transmitted by a laser.

2. The laser machining method of claim 1, wherein the metallic workpiece is made of iron.

3. The laser machining method of claim 1, wherein the metallic workpiece is made of materials selected from a group consisting of magnesium, aluminum, zinc, magnesium alloy, aluminum alloy and zinc alloy.

4. The laser machining method of claim 1, wherein the laser is a semiconductor laser.

5. The laser machining method of claim 1, wherein at least one heating rod is fixed on the metallic workpiece and is electrically connected to the heater controller.

6. The laser machining method of claim 1, wherein a temperature of the metallic workpiece is in a range from about 120° C. to about 278° C. after being heated by the heat controller.

7. The laser machining method of claim 6, wherein a radiation frequency of the laser is 30 KHz, and a radiation time of the laser is 570 μs.
